(19) United States
(12) Patent Application Publication
(10) Pub. No.: US 2024/0419471 A1
(43) Pub. Date: Dec. 19, 2024

(54) DYNAMIC ROUTING OF APPLICATION PROGRAMMING INTERFACE (API) CALLS TO A CONFIDENTIAL COMPUTING VIRTUAL MACHINE

(71) Applicant: Red Hat, Inc., Raleigh, NC (US)

(72) Inventor: Christophe Marie Francois Dupont de Dinechin, Puteaux (FR)

(21) Appl. No.: 18/334,852

(22) Filed: Jun. 14, 2023

(51) Int. Cl. G06F 9/455

(52) U.S. Cl. CPC G06F 9/45558; G06F 2009/45562; G06F 2009/4557; G06F 2009/45595

(57) ABSTRACT

Techniques for sending commands to a container agent of a confidential virtual machine (VM) are disclosed. An example method includes sending a first command from a computing device to a container agent of a confidential VM running on a host computing system. The first command is sent to the container agent through a control plane of the host computing system and causes the container agent to communicate with a relying party to verify confidentiality of the confidential VM. The method also includes receiving network information for the container agent from the relying party and establishing a network connection with the container agent based on the network information received from the relying party. The method also includes sending a second command from the computing device to the container agent of the confidential VM via the network connection.

### TECHNICAL FIELD

Aspects of the present disclosure relate to confidential distributed computing systems, and more particularly to dynamic routing of API calls to confidential virtual machines (VMs) in a distributed computing system.

### BACKGROUND

A container orchestration platform is a platform for developing and running containerized applications and may allow applications and the data centers that support them to expand from just a few machines and applications to thousands of machines that serve millions of clients. Container orchestration engines may provide an image-based deployment module for creating containers and may store one or more image files for creating container instances. Many application instances can be running in containers on a single host without visibility into each other's processes, files, network, and so on. Each container may provide a single function (often called a “service”) or component of an application, such as a web server or a database, though containers can be used for arbitrary workloads. One example of a container orchestration platform is the Red Hat™ OpenShift™ platform built around Kubernetes.

Secure encrypted virtualization (SEV) is a technology that is designed to isolate VMs from the hypervisor and other code that may coexist on the physical host at the hardware level. In this way, SEV may protect VMs from physical threats as well as protect them from other VMs and even the hypervisor itself. SEV is useful in a variety of applications. For example, certain customers of a cloud service may want to secure their VM-based workloads from the cloud administrator to keep their data confidential and minimize their exposure to bugs in the cloud provider's infrastructure.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example computer system architecture, in accordance with some embodiments of the present disclosure.

FIG. 2 is a block diagram that illustrates an example system for implementing a secure channel for a tenant interface, in accordance with some embodiments of the present disclosure.

FIG. 3 is an example of a tenant interface, in accordance with embodiments of the present disclosure.

FIG. 4 is a process flow diagram for a method of sending commands to a container agent of a confidential VM, in accordance with some embodiments of the present disclosure.

FIG. 5 is a block diagram of a system for sending commands to a container agent of a confidential VM, in accordance with some embodiments of the present disclosure.

FIG. 6 is a block diagram of an example computing device that may perform one or more of the operations described herein, in accordance with some embodiments of the present disclosure.

### DETAILED DESCRIPTION

The present disclosure describes techniques for creating a secure communication channel for communicating with a confidential VM in a distributed (i.e., cloud) computing system, including container orchestration platforms such as OpenShift™ and Kubernetes.

A cloud computing system may provide a serverless or cluster-based framework for the performance of client applications. For example, the framework may execute functions of a client's web application. The framework may invoke one or more serverless resources to execute the functions for the client on one or more worker nodes of a computing cluster. The worker nodes may be physical computing systems or may be execution environments within a such as VMs and containers.

The cloud computing system may dynamically manage the allocation and provisioning of resources within a computing framework referred to herein as a container cluster. The container cluster may be managed by a host system referred to herein as a container-orchestration system.

Each container provides an isolated execution environment for processing tasks related to the client applications, sometimes referred to as workloads. To instantiate a new container, the container orchestration system uploads a container image that provides instructions for how to build the container. The container image describes the allocated computing resources and file systems for a container instance to be instantiated, such as the container's operating system, applications to be executed, processing tasks to be handled, etc. The container image may include various base files that are required for minimal functioning and are provided by the host, as well as client-specific files that are specific to the client's applications and processes.

In some cases, the owner of the workload (also referred to herein the tenant) may want to protect the confidentiality of their workloads, which includes preventing the host system from having access to those workloads. For that reason, confidential cloud computing systems have been developed.

A confidential cloud computing system is one that uses cryptographic technology to provide a level of isolation between the host systems and the tenant workloads. Examples of such cryptographic technology include Advanced Micro Devices (AMD) SEV and Intel® trusted domain extensions (TDX). The containers created by such a system may be operated within what is referred to as a confidential VM. The memory used by a container within a confidential VM is usually encrypted in the memory controller of the system's processors. This guarantees that the data in memory for the container will not be accessible to the host system.

However, the host system does have some access to the containers within secure VMs. For example, instructions to load a container image or initiate or stop the execution of a workload may be transmitted to the VM through communication channels operated by the host. Additionally, the host system may need to communicate with the confidential VM for implementing various orchestration functions, such as the allocation and provisioning of resources to be used by the VM. Such communications between the host and the VM are unencrypted, which may prevent a security concern from the standpoint of the tenant. For example, the host may have the ability to execute commands that allow it to monitor processes executing on the VM, access data logs, or even access the VMs memory.

To address this potential security concern, confidential cloud computing systems may be configured to block certain types of commands from being transmitted to the confidential VM. For example, commands for requesting performance metrics or historical logs from the VM can be blocked. However, if the tenant uses the same communication interface to communicate with the VM, blocking these commands also blocks the tenant from executing such commands and receiving potentially useful information. Nevertheless, this has been considered an acceptable tradeoff for the enhanced security that it provides.

Embodiments of the present disclosure provide techniques to create a separate and secure tenant interface for communicating with confidential VMs running in a host computing system. The tenant interface can be encrypted and can be configured to provide VM access to approved users. The tenant interface is separate from the host interface and provides isolation between host-related operations and tenant operations, further enhancing security. This technique improves the computing system by allowing tenants to access certain capabilities of their confidential VMs that would otherwise be blocked through the host interface. Accordingly, a tenant can have confidence in the security of their data while also having access to useful information such as performance metrics and historical logs, which were previously inaccessible.

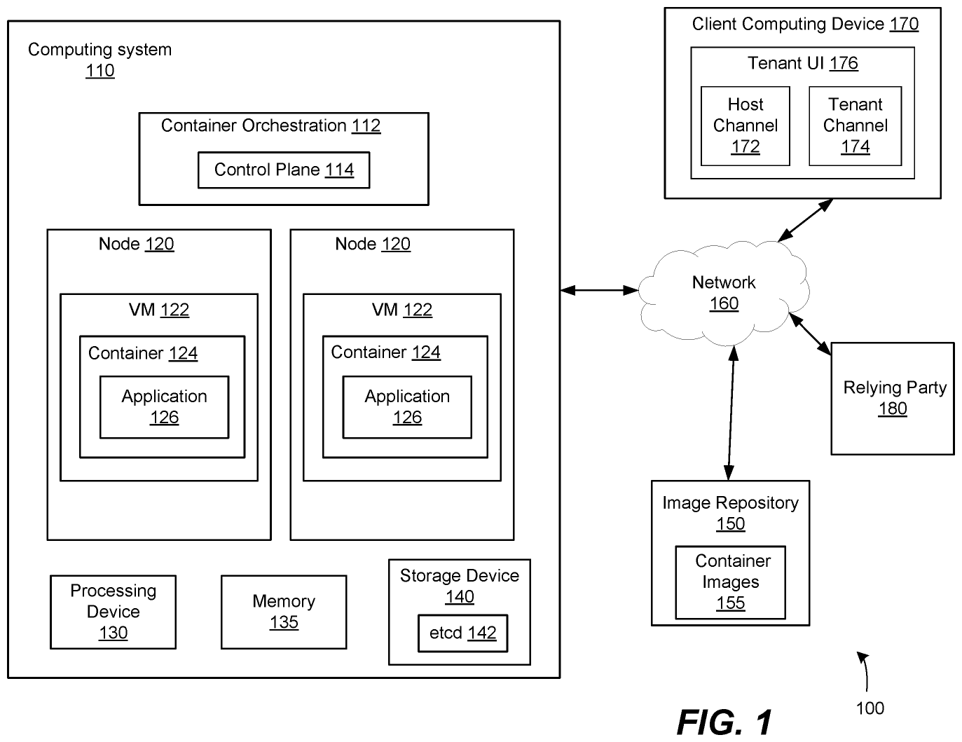

FIG. 1 is a block diagram that illustrates an example computer system architecture, in accordance with some embodiments of the present disclosure. The computing system 110 may be a distributed computing cluster that serves as a cloud computing platform. In some embodiments, the computing system 100 may be a Kubernetes-based container orchestration platform.

Resources of the computing system 110 are provisioned on behalf of tenants by allocating and orchestrating available host resources. Computing system 110 includes container orchestration system 112 to instantiate and manage containers and container workloads across one or more nodes 120 of the computing system 110. The nodes 120 may be physical host machines or VMs in communication with one another. For example, nodes 120 may each be a physical host machine. Although FIG. 1 depicts only two nodes 120, computing system 110 may include any number of nodes.

The computing system 110 may include a processing device 130, memory 135, and storage device 140. Processing device 130 may also include one or more special-purpose processing devices such as an application specific integrated circuit (ASIC), a field programmable gate array (FPGA), a digital signal processor (DSP), network processor, or the like. Memory 135 may include volatile memory devices (e.g., random access memory (RAM)), non-volatile memory devices (e.g., flash memory) and/or other types of memory devices. Storage device 140 may be one or more magnetic hard disk drives, a Peripheral Component Interconnect (PCI) solid state drive, a Redundant Array of Independent Disks (RAID) system, a network attached storage (NAS array, etc. Processing device 130 may include multiple processing devices, storage devices, or devices. Processing device 130 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the storage device may include an etcd database 142. The etcd database 142 is a store of information that the cluster uses to control the computing system 110. For example, the etcd database 142 can store information used to control various processes of the cluster such as container configuration, service discovery, task scheduling, access permissions, and others. Contents of the etcd database 142 may be indexed by container identifier (e.g., node, VM, and container identifiers). The etcd database 142 may be accessed by various processes executing on the container orchestration system 112 and the nodes 120.

Each node 120 may execute one or more confidential VMs 122 for executing client workloads, shown in FIG. 1 as applications 126. The confidential VM provides a secure environment in which the VMs memory is encrypted so that the workload data is accessible the client owner of the VM but not the host computing system. Each VM 122 may include one or more containers 124 that provide an isolated execution environment for the client's applications 126. A container hosted within a confidential VM may be referred to as a confidential container.

The applications 126 may include any type of executable program, including operating system files and components of client applications such as databases, Web servers, and other services, functions, and workloads. In some embodiments, the containers are executed inside of Kubernetes pods (not shown), which provide for grouping of containers so that the containers within a single pod can share the same resources, allowing them to communicate between each other as if they shared the same physical hardware, while remaining isolated to some degree.

The container orchestration system 112 can include a control plane 114 that exposes applications to internal and external networks by defining network policies that control communication with containerized applications (e.g., incoming HTTP or HTTPS requests for services inside the cluster). For example, the control plane 114 may include REST APIs which expose objects as well as controllers which read those APIs, apply changes to objects, and report status or write back to objects. The control plane 114 manages workloads on the nodes 120 and also executes services that are required to control the nodes 120 to facilitate deployment, scaling, and management of containerized software applications. In some embodiments, the control plane 114 may include a container orchestration API (e.g., Kubernetes API server). Host users with suitable credentials may be able to communicate with the container orchestration API to facilitate management of the computing platform 110. Client users with suitable credentials may be able to communicate with the container orchestration API to facilitate management of the client's confidential VMs.

The container orchestration system 112 may scale a service in response to workloads by instantiating additional containers with service instances in response to an increase in the size of a workload being processed by the nodes. In this way, the container orchestration system 112 may allow applications and the data centers that support them to expand from just a few machines and applications to thousands of machines that serve millions of clients.

The computing system 110 may be accessed by client computing devices 170 through the network 160. The client computing device 170 may be owned and operated by a system administrator of the computing system 110 or by a tenant of the computing system 110. The tenant may be the owner and operator of one or more confidential VMs 122 running on the host computing system 110. The client computing device 170 may include one or more software components for communicating with the computing system 110. For example, the client computing device 170 may include a host channel 172 for issuing host side commands and/or a tenant channel 174 for issuing control commands used to control tenant owned VMs, containers, and workloads. A user operating the computing device 170 may use either the host channel 172 or the tenant channel 174 depending on the type access allowed to the user, the type of commands that are to be issued, and/or the communication channel to be used to access the VM 122. The host channel 172 and the tenant channel 174 may use different user credentials to gain access to the computing system 110. The host channel 172 and the tenant channel 174 may be separate components or they may be included as components of a tenant user interface (UI) 176 as shown in FIG. 1.

The host channel 172 and the tenant channel 174 may be command line interfaces. In some embodiments, the host channel 172 is a kubectl tool used for issuing commands that refer to the host API (e.g., kubectl delete). The host-side commands may include commands to create or reconfigure a confidential VM (e.g., kubectl apply), commands to destroy it (e.g., kubectl delete) or commands to monitor its status (e.g., kubectl describe). Host-side commands may be received from the host channel 172 through the control plane 114, which may include an API server (e.g, kube-apiserver).

The tenant channel 174 may be a kubectl tool used for issuing kubectl commands to the confidential VM 122. The control commands may include commands that enable a tenant of the computing system 110 to control and monitor the confidential VMs 122 under the tenants ownership and control. For example, control commands may include commands to obtain container logs (e.g., “kubectl logs”, to execute commands within containers (e.g, “kubectl exec”, copy files from containers (e.g., “kubectl cp”), and others. In some embodiments, some control commands may be received from the tenant channel 174 through the control plane 114, e.g., through the control plane's API server. When the tenant interface is established, as described further below, most or all of the commands may be received from the tenant channel 174 through the tenant interface, bypassing the control plane 114 and the host interface.

The container orchestration system 112 may provide an image-based deployment module for creating containers. In some embodiments, container orchestration system 112 may pull container images 155 from a remote image repository 150 which is communicatively coupled to the container orchestration system 112 through a network 160. Network 160 may be a public network (e.g., the internet), a private network (e.g., a local area network (LAN) or wide area network (WAN)), or a combination thereof. In one embodiment, network 160 may include a wired or a wireless infrastructure. In some embodiments, the network 160 may be an L3 network.

The container images 155 contain the instructions needed to build a container. For example, container images 155 may contain the operating system and other executable programs to be run inside the container 124, as well as instructions for how to build the container 124 and what applications should be executed when the container is built. The container image 155 can hold the source code, libraries, dependencies, environment configuration, tools, and other files needed for the client's application to run. Container images 155 may be defined and created by the client and may determine specific tasks or workloads that should run on the container 124. Container images may be encrypted by the client to preserve the confidentially of the container image's code from the host computing system 110. The image repository 150 may be connected to the computing system 110 through the network 160 as shown or may also be included as a storage repository within the computing system 110.

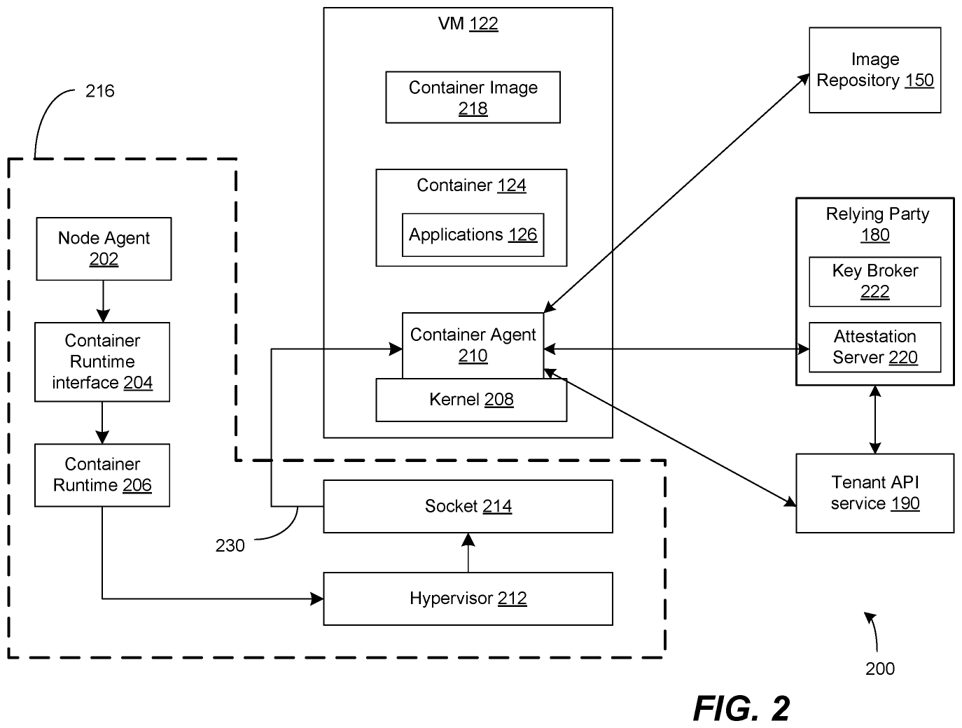

When a container 124 is to be instantiated one or more container images 155 may be pulled from the remote repository by the container orchestration system 112 in accordance with instructions from the client received through the control plane 114. Before a container 124 is instantiated from the loaded container image, a verification process may be performed to verify that the VM 122 is properly configured as a confidential VM. This verification process may be referred to as remote attestation and is performed, in part through a relying party 180, which is able to communicate directly with the VM 122 without going through the control plane 114 as described further in a relation to FIG. 2. In this way, communications between the relying party 180 and the VM 122 can be performed in the encrypted domain rather than unencrypted domain of the host. The remote attestation process is described further in relation to FIG. 2. The relying party 180 may be connected to the computing system 110 through the network 160 as shown or may also be included as a process running within the computing system 110. For example, the relying party 180 may be a process running within one or more confidential VMs 122.

In embodiments of the present disclosure, the relying party 180 is also configured to enable the creation of a secure communication channel that enables the client computing device 170 to communicate directly with the confidential VM 122 in the encrypted domain through a tenant interface that is separate from the host interface and bypasses the control plane 114. Since the communications are not accessible to the host computing system 110, commands that would normally be blocked by the VM 122 to ensure confidentiality can now be allowed. Example techniques for implementing the secure communication channel for a tenant interface are described further in relation to FIGS. 2-4.

FIG. 2 is a block diagram that illustrates an example system 200 for implementing a secure channel for a tenant interface, in accordance with some embodiments of the present disclosure. The system 200 may implemented, at least partly, in a confidential distributed computing system, such as the computing system 110 of FIG. 1.

As described above, the confidential VM 122 may be running on one of the nodes 120 shown in FIG. 1. Communications between the host computing system 110 and the VM 122 may be performed through a software stack running on the node 120, which may include a node agent 202, a container runtime interface 204, a container runtime, 206, a hypervisor 212, and a socket 214. These components may be collectively referred to as the host interface 216. However, it will be appreciated that the host interface 216 may also be considered as including the control plane 114, which may not be running on the same node. Host-side commands from the host channel 172 (FIG. 1) may be sent to the VM 122 through the host interface 216.

The node agent 202 is the primary software tool that controls the operation of each node. The node agent 202 receives instructions through the control plane 114 for instantiating and monitoring containers. In some embodiments, the node agent 202 may be a Kubernetes kubelet. The container runtime 206 is software responsible for running containers, and the container runtime interface 204 is an API that enables the container runtime 206 to coordinate with the node agent 202. In some embodiments, the container runtime interface 204 may include a CRI-O container engine and containerd daemon. The container runtime 206 may be a kata container runtime and may also include a shim process that records encrypted container output.

The container runtime 206 communicates with the VM 122 through the hypervisor 212 and optionally through a socket 214 (e.g., VSOCK), which facilitates communication between VMs and their host. Communication between the socket 214 and the container agent 210 is shown as communication link 230. After the tenant interface to the container agent 210 is established, the communication link 230 can be eliminated. It will be appreciated that the host interface 216 described herein is one example of a host interface that could be implemented in accordance with the disclosed techniques and that other arrangements are also possible.

Communications from the host are received at the VM 122 by the container agent 210, which runs on top a kernel 208 running inside the VM 122, the kernel 208 being the most privileged component of the VMs operating system. The container agent 210 can manage container processes inside the VM 122, responsive to instructions received from the container runtime 206 running on the host. In some embodiments, the container agent 210 is a kata agent. The container agent 210 may be configured to block the processing of specific types of commands that could potentially be received from the host computing system 110 through the container runtime 206. Additionally, as discussed further below, when the separate tenant interface has been established, the container agent 210 may block all commands received through the host interface 216.

The tenant can send instructions to the host through the control plane 114 to create the VM 122 and instantiate containers 124 within the VM 122 to run specific tenant workloads. To generate the container 124, the container agent 210 may be instructed to pull an encrypted container image 218 of the tenant's choosing from the image repository 150 into a storage device of the VM 122. Before decrypting the stored container image 218 and instantiating the running container 124, a verification process is performed to ensure that the VM 122 is configured properly to ensure confidentiality.

The verification process may be performed by a third party, referred to herein as relying party 180, which includes an attestation server 220 and a key broker 222. The attestation server 220 can communicate directly with the container agent 210 through a direct network connection that does not involve the host interface 216 or the host's control plane 114. For example, the container agent 210 may have an Internet protocol (IP) network address and port number that is known to the relying party. The relying party 180 and the container agent 210 may also use digital certificates such as Transport Layer Security (TLS) certificates to encrypt the communications between them. Thus, communications between the attestation server 220 and the container agent 210 can be encrypted and are inaccessible to the host. During the verification process, the container agent 210 submits evidence to the attestation server 220 and the attestation server 220 processes the evidence to determine whether certain criteria met, such as whether the VM's memory is encrypted.

If the evidence provided by the container agent 210 meets the specified criteria for ensuring confidentiality, the relying party 180 may obtain a cryptograph key or other secret from the key broker 222 and send it to the container agent 210. The container agent 210 is then able to use the received key to decrypt the stored container image 218. The container agent 210 then decrypts, unpacks, and mounts the container image 218 to instantiate the running container 124, which contains the tenant's applications 126. The key broker 222 may also provide, through the direct network connection, additional confidential information that the application 126 may need to operate, such as database passwords, and the like. In this way, the tenant can have confidence that the tenant's workloads are confidential from the host computing system 110.

In accordance with presently disclosed techniques, the relying party 180 may also be used to establish the separate tenant interface that enables the tenant to communicate directly to the container agent 210. Specifically, the relying party 180 has information (network address, port number, digital certificates, etc.) that enables it to communicate directly with the container agent 210 without going through the host interface 216. This same information may then also be used to create a secure encrypted channel between the client's computing device 170 and the container agent 210 that bypasses the host interface 216. The tenant interface may include a tenant API service 190, which is a service that receives commands from the tenant channel 174 (FIG. 1) and relays these commands to the container agent 210 through the same network connection that the relying party 180 uses for the remote attestation. The tenant API service 190 is then able to send commands to the container agent 210 in a more secure manner since the commands are no longer going through the host interface 216 and can also be encrypted. Thus, the container agent 210 can now be configured to accept commands that it would have blocked otherwise.

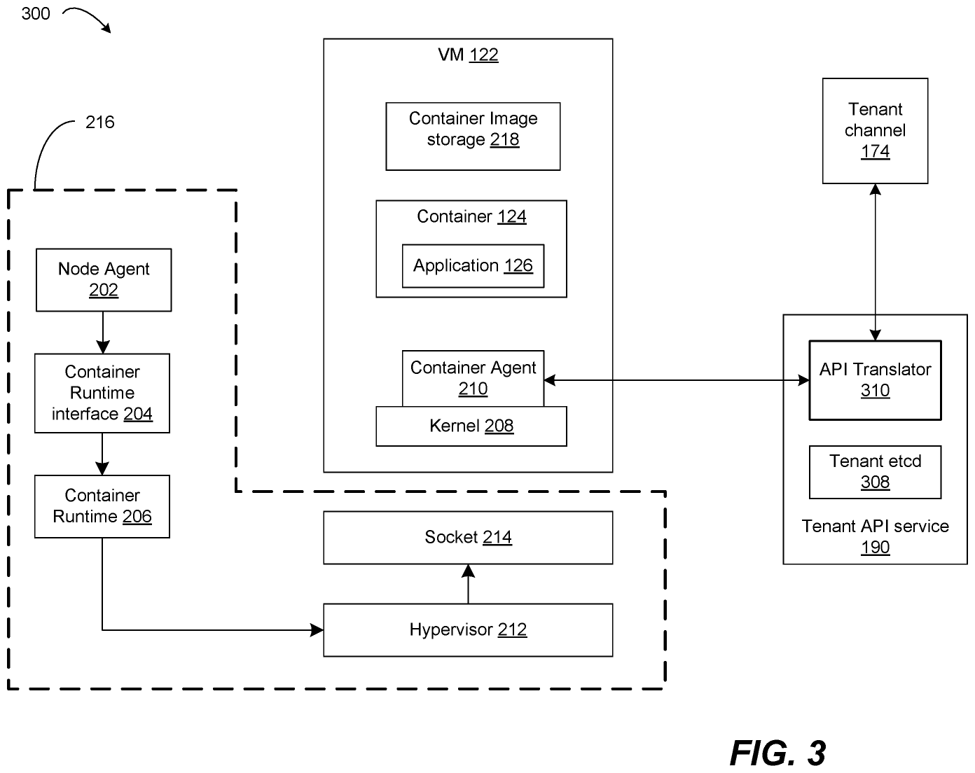

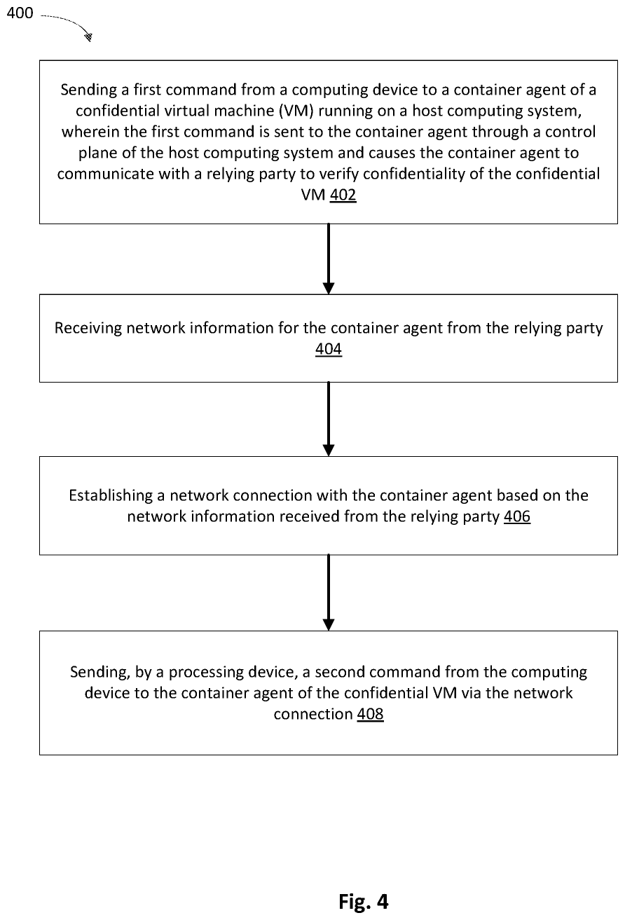

In some examples, the tenant API service 190 may be accessed after the tenant provides user credentials (e.g., username and password), which may be different from the credentials used to gain access to the host interface 216 through the control plane 114 (FIG. 1). Example embodiments of the tenant API service 190 are described further in relation to FIGS. 3 and 4. Depending on the details of a specific embodiment, the tenant API service 190 may be running on the client computing device 170, the relying party 180, or a node 120 of the computing system 110.

In alternative embodiments, it may also be possible to send encrypted commands to the container agent 210 through the host interface 216. For example, a tenant interface could be configured to inject encrypted commands directly into the container runtime 206 for delivery to the container agent 210 through the hypervisor 212 and the socket 214. However, sockets such as VSOCK are generally not equipped to handle encrypted communications. Thus, to make such a solution viable could require a redesign of the socket 214 or only partial encryption of the commands sent from the tenant interface. The embodiments described in relation to FIGS. 2-4 avoid this potential drawback by bypassing the host interface 216, including the hypervisor 212 and the socket 214.

FIG. 3 is an example of a tenant interface, in accordance with embodiments of the present disclosure. The host interface 216 shown in FIG. 3 operates as described in relation to FIG. 2, except that the communication link 230 (FIG. 2) between the socket 214 and the container agent 210 has been eliminated and tenant commands from the tenant channel 174 now pass to the container agent 210 through the tenant API interface 190. Tenant commands from the host channel 172 may still be delivered through the host interface 216. For example, commands related to VM lifecycle may be sent to the host interface 216 to be processed by the container runtime 206. As described further below, the tenant API service 190 may be running on the same computing device as the tenant UI 176 (e.g., computing device 170) or on a separate computing device, such as the relying party 180.

In the embodiment shown in FIG. 3, the tenant API service 190 includes an API translator 310 and a tenant etcd database 308. The tenant etcd database 308 is similar to the etcd database 142 of FIG. 1 and can store information used to control various processes of the tenant's confidential VMs and containers such as container configuration, service discovery, task scheduling, access permissions, and others. Some of the information stored to the etcd database 142 may be tenant-specific information that is not accessible to the host computing system 110, such as permissions, passwords, encryption keys, or other confidential information used to provide access to resources within a container 124. The tenant API service 190 may access information from the tenant etcd database 308 depending on the type of command being processed from the tenant channel 174.

The API translator 310 transforms commands received from the tenant channel 174 into a style that is suitable for the container agent 210. On the host side, host-side commands from the host channel 172 are processed by the API server of control plane 114, the node agent 202, the container runtime interface 204, and the container runtime 206. Each of these components may expose an API that uses different protocols (formatting, syntax, etc.) for receiving and issuing commands or other data. Accordingly, the format of the command received from the user interface may undergo various transformations along the chain of component APIs before reaching the container agent 210 through the host interface 216. The API translator 310 processes commands from the tenant channel 174 to cause the same overall transformation that would be caused by the host interface 216. This enables implementation of the disclosed embodiments without little or no changes to the programming of the tenant UI 176 or the container agent 210.

In some embodiments, the API translator 310 may include copies of the components included in the host interface 216. For example, the API translator 310 may have a similar software stack to that of the host interface 216, including an instance of the same software used to implement the node agent 202, container runtime interface 204, and container runtime 206. These components can perform substantially the same functions as their counterparts from the host interface 216, resulting in the same overall transformation. In some embodiments, the API translator 310 may implement an algorithm or function that provides an equivalent overall transformation compared to the host interface 216 with fewer or no intermediates transformations. In other words, the API translator 310 may include a software component that replicates the overall transformation provided by two or more components of the host interface's software stack.

The API translator 310 may be configured to communicate directly with the container agent 210 in the encrypted domain. In embodiments in which the tenant API service 190 is operating on the client's computing device 170, the relying party 180 (FIG. 2) can share the relevant network information with the client computing device 170, such as the IP address, and port number of the container agent 210, the digital certificates used to encrypt and decrypt the communications, and others. This networking information may be stored, for example, to the tenant etcd database 308.

Once the secure channel between the container agent 210 and the tenant API service 190 is established, any communications not related to the VM lifecycle can go through the tenant API service 190. In Kubernetes, for example, the “kubectl logs” command causes the container agent to return a list of event logs generated by the VM 122 and/or the applications 126 running on the VM. This command may be received through the control plane 114. However, for a confidential VM, the “kubectl logs” command is usually blocked by the container agent 210 to ensure that such log information cannot be exposed to the host computing system 110. The “kubectl logs” command can be sent to container agent 210 through the tenant API service 190 without being blocked, and the resulting logs can be returned to the tenant through the tenant API service 190 in encrypted form without being exposed within the host computing system 110.

Another example of a command that can be sent to the container agent 210 from the tenant API service 190 is the “ExecProcess” API resulting from the “kubectl exec” command. The “kubectl exec” command is used to manually execute a command with a container. The “kubectl exec” command can be used, for example, to perform a maintenance operation or to assist in a debugging procedure. However, as with the “kubectl logs” command, the “kubectl exec” is usually blocked by the container agent 210 to ensure that the host computing system 110 is not able to gain unauthorized access to the processes running in the container 124. The “kubectl exec” command can be sent to container agent 210 through the tenant API service 190 without being blocked.

Other types of commands that may go through the tenant API service 190 include commands to instantiate a container or start or stop the execution of a container, commands for obtaining statistics about the container (metrics), configuring the guest networking, copying files, accessing container input and output (I/O), and others.

In some embodiments, the tenant can also access the container agent 210 through the host interface 216 and may also choose to send commands through the host interface 216 via the control plane 114 even if the secure connection has been established between the tenant API service 190 and the container agent 210. This option may be chosen for commands that present little or no risk of compromising VM confidentiality, such as commands that relate to the lifetime of the VM 122 (e.g., commands to create or delete the VM 122). In some embodiments, if the secure connection has been established between the tenant API service 190 and the container agent 210, then some or all commands received from the host interface 216 may be blocked, so that any blocked commands would have to go through the tenant API service 190.

In some embodiments, the client computing device 170 may be configured to determine whether to route a particular command to the container agent 210 through the control plane 114 of the host computing system 110 or through the tenant API service 190. For example, the tenant UI 176 may be configured to have access to both the API server of the control plane 114 and the tenant API service 190. Upon receiving a command from the tenant user, the computing device 170 can determine, based on the type of command, whether the command should be executed through the host (e.g., create or delete the VM) or though the tenant API service 190 (e.g., “kubectl logs” or “kubectl exec”). The computing device 170 may route the command accordingly. In other embodiments, the host interface 216 and the tenant API service 190 may be accessed separately through different user interfaces running on the computing device 170.

In some embodiments, the tenant API service 190 may be operating on the relying party 180, in which case the tenant channel 174 communicates with the API translator 310 over a network connection, and communication between the tenant channel 174 and container agent 210 are mediated by the relying party 180. In such embodiments, the API translator 310 receives commands from the tenant channel 174 over a first network connection and sends commands to the container agent 210 over a second network connection. The second network connection may be the same connection used by the attestation server 220 to communicate with the container agent 210 (e,g, same IP address, port, digital certificates, etc.). The first network connection between the tenant channel 174 and the API translator 310 may be established by the tenant API service 190 using different network information (network addresses, ports, digital certificates, etc.). Communication between the tenant API service 190 and the tenant channel 174 may be encrypted using a different pair of digital certificates. However, even if communication between the tenant API service 190 and the tenant channel 174 is not encrypted, the host computing system 110 may not have access to the communication since the data and/or commands bypass the host interface 216.

In some cases, the container agent 210 may be configured to establish an isolated network connection with the relying party 180 as opposed to exposing a publicly accessible network connection that is reachable by other computing devices. For example, the tenant may configure the container agent 210 to allow network communication from a single, pre-specified network address known to belong to the relying party 180. The container agent 210 may be configured this way to reduce the possibility of a malicious actor gaining access to the confidential VM 122. In such cases, sharing the network information with the client computing device 170 would not enable the client computing device 170 to successfully communicate with the container agent 210. Deploying the tenant API service 190 in the relying party 180 ensures that the tenant API service 190 will be able to communicate with the container agent 210 using the relying party's access.

In some cases, the direct network connection between the client computing device 170 and the container agent 210 may be preferred over an indirect connection that uses the relying party 180 an intermediary. Accordingly, in some embodiments, different instances of the tenant API service 190 may be deployed on the client computing device 170 and the relying party 180. The client computing device 170 and the relying party 180 may first attempt to establish a direct connection as described above. If the direct connection is established, the API translator 310 running on the client computing device 170 can send commands directly to the container agent 210. If the direct connection fails, the indirect connection may be established, in which case the tenant UI 176 running on the client computing device 170 communicates over the network with API translator 310 running on the relying party 180, and the API translator 310 send commands directly to the container agent 210. For example, the relying party 180 may send network information of the container agent 210 to the tenant API service 190 running on the client computing device 170. If the container agent 210 is not reachable by the tenant API service 190 in this manner, then the tenant API service 190 running on the client computing device 170 can inform the relying party 180 that the direct connection was not successful. The relying party 180 can then configure the separate network connection between the tenant UI 176 running on the client computing device 170 and the API translator 310 running on the relying party.

FIG. 4 is a process flow diagram for a method of sending commands to a container agent of a confidential VM, in accordance with some embodiments of the present disclosure. The method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by the tenant API service 190 (FIGS. 2 and 3) which may reside on the client computing device 170 shown in FIG. 1. The method may begin at block 402.

At block 402, a first command is sent from a computing device to a container agent of a confidential virtual machine (VM) running on a host computing system. The first command is sent to the container agent through a control plane of the host computing system and causes the container agent to communicate with a relying party to verify confidentiality of the confidential VM. For example, the first command may instruct the container to load a container image and/or instantiate a container within the confidential VM based on the container image.

At block 404, network information for the container agent is received from the relying party. The network information may be the same information that the relying party uses to communicate with the container agent to perform attestation, and may include, for example, a network address (e.g., IP address), port number, digital certificates, etc.

At block 406, a direct network connection with the container agent is established based on the network information received from the relying party.

At block 408, a second command is sent from the computing device to the container agent of the confidential VM via the direct network connection without accessing the control plane of the host computing system. For example, the second command may be a command to retrieve logs or metrics from the container agent or execute a function within a container instantiated by the container agent. The first and second commands may be kubectl commands input by a user into a kubectl command line interface.

It will be appreciated that embodiments of the method 400 may include additional blocks not shown in FIG. 4 and that some of the blocks shown in FIG. 4 may be omitted. Additionally, the processes associated with blocks 402 through 408 may be performed in a different order than what is shown in FIG. 4. For example, the method may also include translating the command to a new format that is applicable to the container agent. The translation may be performed by a software stack residing on the computing device that processes the command in the same manner as a similar software stack that resides on the host computing system. The translation may also performed, at least in part, by a translator that generates an equivalent overall transformation of the second command that would be performed by the software stack that resides on the host computing system.

In some embodiments, commands may also be sent from the computing device to the container agent of the confidential VM via the control plane of the host computing system even after establishing the direct network connection with the container agent. Additionally, in some embodiments, commands may be sent from the computing device to the container agent of the confidential VM via the relying party. Such commands may be relayed to the container agent through the relying party if the container agent is not reachable from the computing device or if the network connection established between the computing device and the container agent fails.

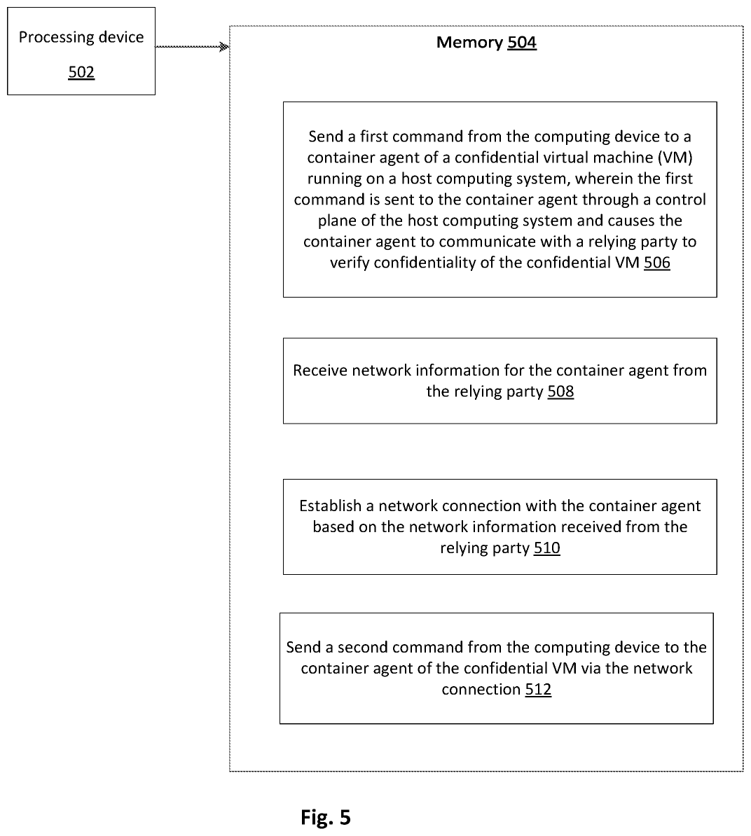

FIG. 5 is a block diagram of a system for sending commands to a container agent of a confidential VM, in accordance with some embodiments of the present disclosure. The system 500 includes a processing device 502 operatively coupled to a memory 504. The memory 504 includes instructions that are executable by the processing device 502 to cause the processing device 502 to send commands to a container agent of a confidential VM without going through the control plane of the host computing system on which the confidential VM resides.

The memory 504 includes instructions 506 to send a first command from the computing device to a container agent of a confidential virtual machine (VM) running on a host computing system. The first command is sent to the container agent through a control plane of the host computing system and causes the container agent to communicate with a relying party to verify confidentiality of the confidential VM.

The memory 504 also includes instructions 508 to receive network information for the container agent from the relying party. The memory 504 also includes instructions 510 establish a direct network connection with the container agent based on the network information received from the relying party. The memory 504 also includes instructions 512 to send a second command from the computing device to the container agent of the confidential VM via the direct network connection without accessing the control plane of the host computing system.

It will be appreciated that various alterations may be made to the process illustrated in FIG. 5 and that some components and processes may be omitted or added without departing from the scope of the disclosure.

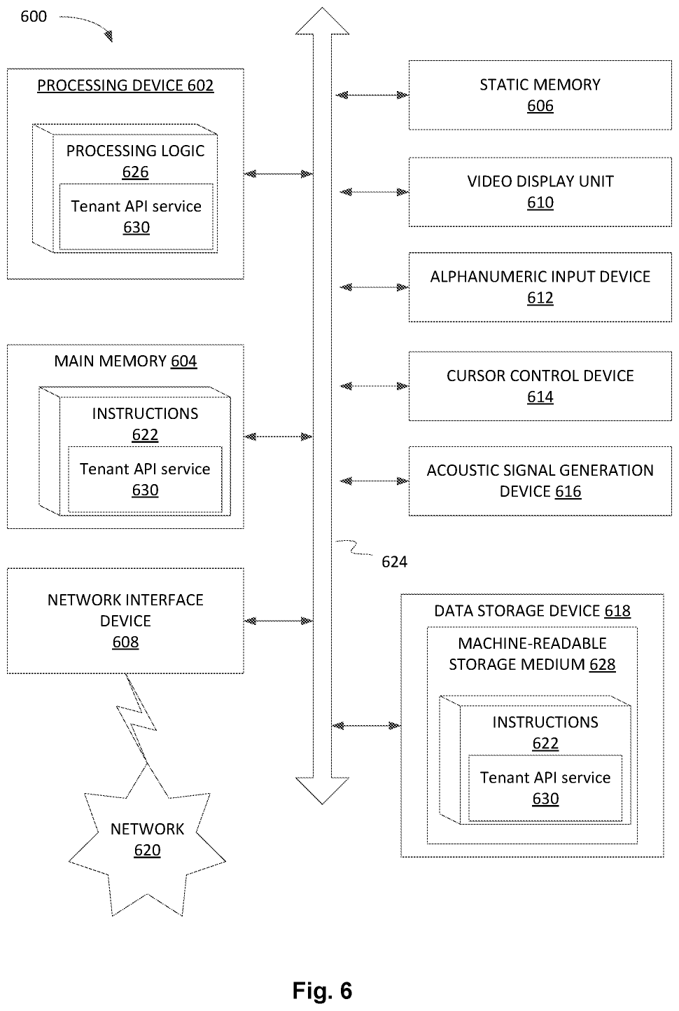

FIG. 6 is a block diagram of an example computing device 600 that may perform one or more of the operations described herein, in accordance with some embodiments of the present disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 624.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 622 that may include a tenant API service 630 comprising instructions for carrying out the operations described herein, in accordance with one or more aspects of the present disclosure. The tenant API service 630 may also reside, completely or at least partially, within main memory 604 and/or within processing device 602 (e.g. within processing logic 626) during execution thereof by computing device 600, main memory 604 and processing device 602 also constituting computer-readable media. The tenant API service 630 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “sending,” “receiving,” “establishing,” “translating,” “converting,” “generating,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the techniques to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the disclosure is not to be limited to the details given herein, but may be modified within the scope and equivalents of the appended claims.

What is claimed is:

1. A method comprising:
sending a first command from a computing device to a container agent of a confidential virtual machine (VM) running on a host computing system, wherein the first command is sent to the container agent through a control plane of the host computing system and causes the container agent to communicate with a relying party to verify confidentiality of the confidential VM;
receiving network information for the container agent from the relying party;
establishing a network connection with the container agent based on the network information received from the relying party; and
sending, by a processing device, a second command from the computing device to the container agent of the confidential VM via the network connection.

2. The method of claim 1, further comprising translating the second command from a first format generated by a user interface to a second format applicable to the container agent.

3. The method of claim 2, wherein the host computing system comprises a first instance of a software stack that passes the first command from the control plane to the container agent, and wherein translating the second command comprises passing the second command through a second instance of the software stack.

4. The method of claim 2, wherein the host computing system comprises a software stack that passes the first command from the control plane to the container agent, and wherein translating the second command comprises generating an equivalent transformation of the second command that would be performed by the software stack.

5. The method of claim 1, wherein the second command is a command to retrieve logs or metrics from the container agent or execute a function within a container instantiated by the container agent.

6. The method of claim 1, wherein the first and second commands are kubectl commands received from a kubectl command line interface.

7. The method of claim 1, further comprising, after establishing the network connection with the container agent, sending a third command from the computing device to the container agent of the confidential VM via the control plane of the host computing system.

8. The method of claim 1, further comprising sending a third command from the computing device to the container agent of the confidential VM via the relying party over a second network connection between the relying party and the container agent.

9. A computing device comprising:
a memory; and
a processing device operatively coupled to the memory, the processing device to:
send a first command from the computing device to a container agent of a confidential virtual machine (VM) running on a host computing system, wherein the first command is sent to the container agent through a control plane of the host computing system and causes the container agent to communicate with a relying party to verify confidentiality of the confidential VM;
receive network information for the container agent from the relying party;
establish a network connection with the container agent based on the network information received from the relying party; and
send a second command from the computing device to the container agent of the confidential VM via the network connection.

10. The computing device of claim 9, wherein the processing device is further to translate the second command from a first format generated by a user interface to a second format applicable to the container agent.

11. The computing device of claim 10, wherein the host computing system comprises a first instance of a software stack that passes the first command from the control plane to the container agent, and wherein, to translate the second command, the processing device is to pass the second command through a second instance of the software stack.

12. The computing device of claim 10, wherein the host computing system comprises a software stack that passes the first command from the control plane to the container agent, and wherein, to translate the second command, the processing device is to generate an equivalent overall transformation of the second command that would be performed by the software stack.

13. The computing device of claim 9, wherein the second command is a command to retrieve logs or metrics from the container agent or execute a function within a container instantiated by the container agent.

14. The computing device of claim 9, wherein the first and second commands are kubectl commands received from a kubectl command line interface.

15. The computing device of claim 9, wherein, after the network connection with the container agent is established, the processing device is further to send a third command from the computing device to the container agent of the confidential VM via the control plane of the host computing system.

16. The computing device of claim 9, wherein the processing device is further to send a third command from the computing device to the container agent of the confidential VM via the relying party, and wherein the relying party sends the third command to the container agent via a second network connection between the relying party and the container agent.

17. A non-transitory computer-readable storage medium comprising instructions that, when executed by a processing device, cause the processing device to:
send a first command from a computing device to a container agent of a confidential virtual machine (VM) running on a host computing system, wherein the first command is sent to the container agent through a control plane of the host computing system and causes the container agent to communicate with a relying party to verify confidentiality of the confidential VM;
receive network information for the container agent from the relying party;
establish a network connection with the container agent based on the network information received from the relying party; and
send, by the processing device, a second command from the computing device to the container agent of the confidential VM via the network connection.

18. The non-transitory computer-readable storage medium of claim 17, further comprising instructions that cause the processing device to translate the second command from a first format generated by a user interface to a second format applicable to the container agent.

19. The non-transitory computer-readable storage medium of claim 17, wherein the host computing system comprises a software stack that passes the first command from the control plane to the container agent, and wherein the instructions to translate the second command further comprise instructions that cause the processing device is to generate an equivalent overall transformation of the second command that would be performed by the software stack.

20. The non-transitory computer-readable storage medium of claim 17, comprising instructions that cause the processing device to send a third command from the computing device to the container agent of the confidential VM via the relying party over a second network connection between the relying party and the container agent.
